(19) United States
(12) Patent Application Publication
(10) Pub. No.: US 2015/0273355 A1
(43) Pub. Date: Oct. 1, 2015

(54) METHOD AND APPARATUS FOR SECURING FRACTIONATION TRAYS

(71) Applicant: GTC Technology US LLC, Houston, TX (US)

(72) Inventors: SooWoong KIM, Flower Mound, TX (US); Larry W. BURTON, Waxahachie, TX (US)

(73) Assignee: GTC Technology US LLC, Houston, TX (US)

(21) Appl. No.: 14/736,941

(22) Filed: Jun. 11, 2015

Related U.S. Application Data
(63) Continuation-in-part of application No. 13/401,601, filed on Feb. 21, 2012, now Pat. No. 9,072,986.
(60) Provisional application No. 61/445,898, filed on Feb. 23, 2011.

(51) Int. Cl. B01D 3/32

(52) U.S. Cl. CPC B01D 3/326

(57) ABSTRACT

A chemical-process system includes a chemical-process column and a support disposed on an interior of the chemical-process column. A tray is disposed on a top surface of the support. A bolt is disposed through the tray and a clamp is disposed below the tray. The clamp has a notch formed therein for receiving a head region of the bolt. The clamp engages a bottom surface of the tray and a bottom surface of the support. The bolt is able to angularly displace with respect to at least one of the tray and the clamp.

### CROSS-REFERENCE TO RELATED APPLICATIONS

This application is a continuation-in-part of U.S. patent application Ser. No. 13/401,601, filed Feb. 21, 2012. U.S. patent application Ser. No. 13/401,601 claims priority to, and incorporates by reference for any purpose the entire disclosure of, U.S. Provisional Patent Application No. 61/445,898, filed Feb. 23, 2011. U.S. patent application Ser. No. 13/401,601 and U.S. Provisional Patent Application No. 61/445,898 are incorporated herein by reference.

### BACKGROUND

1. Field of the Invention

The present application relates generally to fractionation tray hardware and more particularly, but not by way of limitation, to hardware utilized for securing fractionation trays within a chemical-process column.

2. History of the Related Art

Chemical-process columns are utilized to separate select components from a multicomponent stream. Successful separations in the chemical-process column are dependent upon intimate contact between heavier fluids and lighter fluids. Several types of contact mechanisms enhance contact between a fluid in a vapor phase and a fluid in a liquid phase. Contact devices such as, for example, trays are characterized by relatively high pressure drop and relatively high fluid hold-up. Other types of contact apparatus include high-efficiency packing. High-efficiency packing is energy-efficient because it has low pressure drop and low fluid hold-up.

Typically, chemical-process columns utilize either trays, packing, or combinations thereof. Tray designs such as, for example, sieve trays and valve tray are effective and often applied in chemical-process columns. A sieve tray is constructed with a large number of apertures formed in a bottom surface. The apertures permit an ascending lighter fluid to interact with a heavier fluid that is flowing across the sieve tray from a downcomer. Regions of the sieve tray surface are generally referred to as “active” or “inactive”. Typically, active tray regions allow the ascending lighter fluid to pass therethrough for interaction and mass transfer with the heavier fluid. Conversely, inactive tray regions do not permit such interaction. It is generally desirable to have as much of a tray surface as possible be “active”. Thus, it is desirable to secure the tray to an interior of the chemical-process column in a manner that minimizes inactive tray regions.

Trays are typically secured within chemical-process columns by clamps that engage a support affixed to an interior of the chemical-process column. Typically, the clamps are tightened by way of bolts arranged generally perpendicular to the tray. This method, while effective, is not without problems. First, in most cases, securement of a tray to the support requires a first individual positioned above the tray and a second individual positioned below the tray. Secondly, alignment of the fasteners may vary from one clamp to another. Moreover, in cases where the support is thick, the clamps may deflect. As will be described in more detail below, such deflection induces a lateral force in the bolts which, over long periods of use, may cause the clamps to disengage from the support.

Additionally, the requirement of a second individual positioned below the tray is costly. It would thus be advantageous to provide a clamp assembly utilizing a bolt secured therein. If the bolt head is also secured against rotation during tightening, the likelihood of the bolt falling out and/or the need to secure the bolt against turning is eliminated.

### SUMMARY

The present invention relates to tray hardware and more particularly, but not by way of limitation, to hardware utilized for securing trays within a chemical-process column. One aspect of the present invention relates to a chemical-process system. The chemical-process system includes a chemical-process column and a support disposed on an interior of the chemical-process column. A tray is disposed on a top surface of the support. A bolt is disposed through the tray and a clamp is disposed below the tray. The clamp has a notch formed therein for receiving a head region of the bolt. The clamp engages a bottom surface of the tray and a bottom surface of the support. The bolt is able to angularly displace with respect to at least one of the tray and the clamp.

Another aspect of the present invention relates to a method for securing a tray in a chemical-process column. The method may include placing the tray on a support formed in an interior of the chemical-process column and securing the tray to the support via a clamp system comprising a clamp and a bolt. The bolt is articulated with respect to at least one of the clamp or the tray.

Yet another aspect of the present invention relates to a clamp assembly having a bolt retainer formed therein for receiving a head of a bolt. In various embodiments, the bolt retainer secures the bolt from accidental disengagement from the clamp during assembly and secures the bolt against rotation during tightening. This allows installation and tightening to be accomplished by a single worker.

### BRIEF DESCRIPTION OF THE DRAWINGS

For a more complete understanding of the present invention and for further objects and advantages thereof, reference may now be had to the following description taken in conjunction with the accompanying drawings in which:

FIG. 1A is a perspective view of a prior-art chemical-process column with various sections cut away for illustrating a variety of internal components.

FIG. 1B is a cross-sectional view of a prior-art clamp system;

FIG. 2 is a cross-sectional view of a chemical-process column having a clamp system disposed therein according to an exemplary embodiment;

FIG. 3 is an end view of a clamp system according to an exemplary embodiment;

FIG. 4 is a side view of a clamp system according to an exemplary embodiment;

FIG. 5 is a side view of a clamp system according to an exemplary embodiment;

FIG. 6A is a cross-sectional view of a chemical-process column having a clamp system disposed therein according to an exemplary embodiment;

FIG. 6B is a bottom perspective view of a clamp according to an exemplary embodiment;

FIG. 7 is an end view of a clamp system according to an exemplary embodiment;

FIG. 8 is a side view of a clamp system according to an exemplary embodiment;

FIG. 9 is perspective view of a clamp system with a bolt retainer according to an exemplary embodiment;

FIGS. 10A-10D are bottom views of various embodiments of a clamp system with a bolt retainer according to an exemplary embodiment;

FIG. 11A is a bottom perspective view of a clamp system with a bolt retainer and retainer tabs according to an exemplary embodiment; and

FIG. 11B is a side view of a clamp having a cut out bolt retainer and bolt retainer tabs according to an exemplary embodiment.

### DETAILED DESCRIPTION

Various embodiments of the present invention will now be described more fully with reference to the accompanying drawings. The invention may, however, be embodied in many different forms and should not be construed as limited to the embodiments set forth herein; rather, the embodiments are provided so that this disclosure will be thorough and complete, and will fully convey the scope of the invention to those skilled in the art.

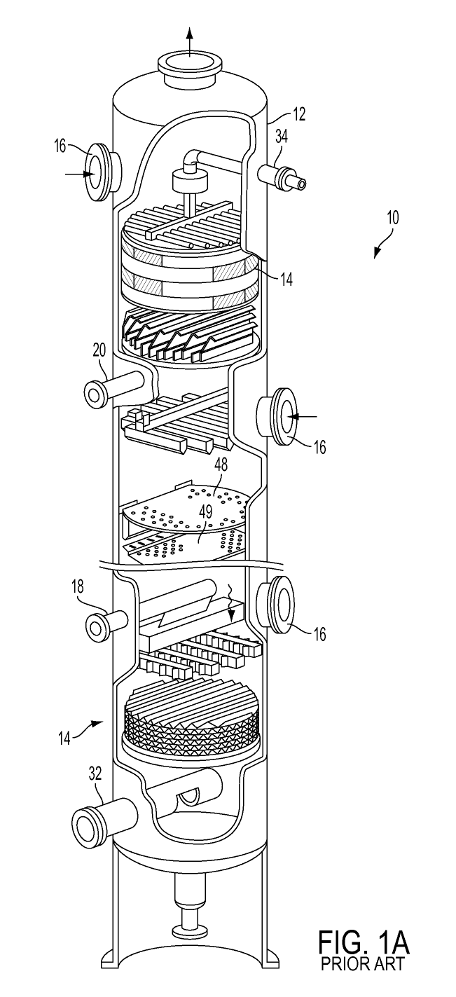

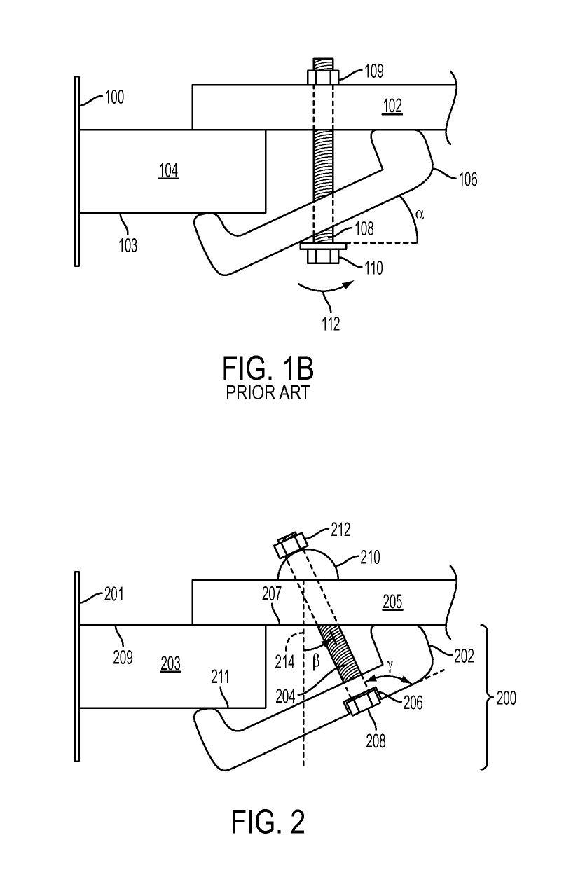

FIG. 1A, is a perspective view of a prior-art chemical-process column with various sections cut away for illustrating a variety of internal components. A chemical-process column 10 typically comprises a cylindrical tower 12 having at least one of a plurality of packing-bed layers 14 and a plurality of trays 48, 49 disposed therein. In many instances, the plurality of trays 48, 49 are valve trays or sieve trays.

Still referring to FIG. 1A, a plurality of manways 16 are likewise constructed for facilitating access to an internal region of the cylindrical tower 12. Also provided are a side-stream draw-off line 20, a heavier-fluid side-stream-input feed line 18, and a side-stream lighter-fluid feed line (or reboiler-return line) 32. A reflux-return line 34 is provided atop the chemical-process column 10.

FIG. 1B is a cross-sectional view of a prior-art clamp system. A tray 102 is secured within an interior space of a chemical-process column 100. A support 104 is affixed to an interior of the chemical-process column 100. The tray 102 rests on the support 104. Typically, a clamp 106 is connected to a bottom surface of the tray 102 via, for example, a bolt 108. A nut 109 is disposed above the tray 102, and receives the bolt 108. Tightening the nut 109 causes the clamp 106 to engage a bottom surface 103 of the support 104 thereby securing the tray 102 within the chemical-process column 100.

Still referring to FIG. 1B, in situations where the clamp 106 engages the support 104 prior to engaging the tray 102, further tightening of the nut 109 causes the clamp 106 to tilt with respect to the bolt 108. An angle α between the bolt 108 and the clamp 106 causes a head region 110 of the bolt 108 to not sit flush on the clamp 106. This arrangement may, over long periods of use, cause the bolt 108 to deflect in a direction as illustrated by arrow 112. Such deflection pulls the clamp 106 toward a center of the tray 102. Such deflection weakens an engagement between the clamp 106 and the support 104. In some cases, such deflection entirely disengages the clamp 106 from the support 104.

Still referring to FIG. 1B, installation of the tray 102 typically requires at least a first worker positioned above the tray 102 and at least a second worker positioned below the tray 102. The second worker must secure the head region 110 of the bolt 108 while the first worker tightens the nut 109. In situations where only a single worker is available, installation of the clamp 106 often requires the head region 110 of the bolt 108 to be welded to the clamp 106.

FIG. 2 is a cross-sectional view of a chemical-process column having a clamp system disposed therein according to an exemplary embodiment. A support 203 is secured to an interior of a chemical-process column 201. At least a portion of a bottom surface 207 of a tray 205 is disposed on at least a portion of a top surface 209 of the support 203. A clamp system 200 includes a clamp 202 and a bolt 204. A nut 212 is disposed on a top surface of the tray 205 for receiving the bolt 204. In a typical embodiment, tightening the nut 212 causes the clamp 202 to engage a bottom surface 211 of the support 203. In a typical embodiment, the clamp 202 includes a notch 206 that is sufficiently sized to allow a head region 208 of the bolt 204 to be received and secured therein. In a typical embodiment, the notch 206 captures the head region 208 of the bolt 204 and prevents rotation and deflection of the bolt 204 during tightening of the nut 212. Such an arrangement permits securement of the tray 205 within the chemical-process column 201 by a single worker positioned above the tray 205 thereby eliminating the need for multiple workers. Thus, the clamp system 200 allows lower-cost installation.

Still referring to FIG. 2, a washer 210 and the nut 212 are disposed above the tray 205. In a typical embodiment, the washer 210 is dome shaped. The washer 210 and the nut 212 receive the bolt 204. In a typical embodiment, the washer 210 allows the bolt 204 to be received at an angle β with respect to a vertical axis 214. The washer 210 thereby permits the bolt 204 and the clamp 202 to remain at an angle γ of generally 90 degrees relative to each other despite the angle β between the bolt 204 and the vertical axis 214. Such an arrangement ensures that the head region 208 of the bolt 204 remains flush against the clamp 202 thereby reducing a tendency of the bolt 204 or the clamp 202 to deflect toward the center of the tray 205.

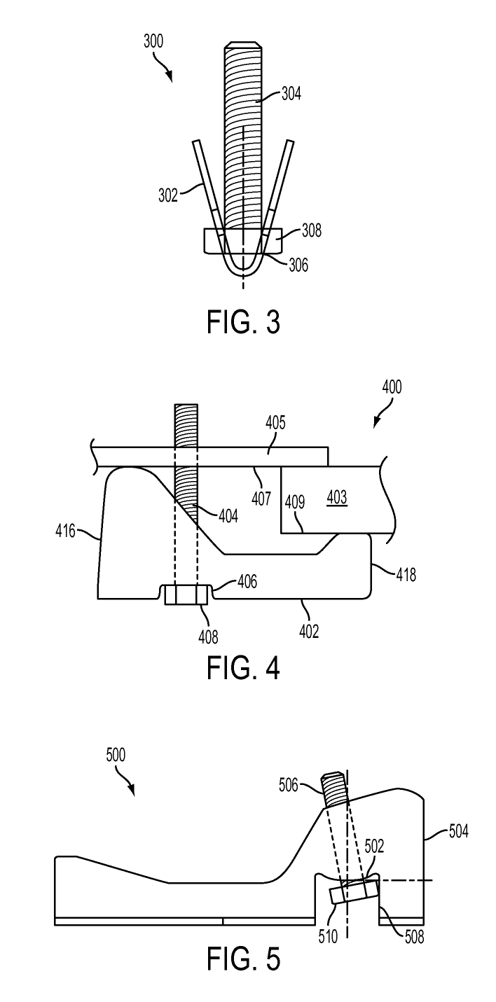

FIG. 3 is an end view of a clamp system according to an exemplary embodiment. A clamp system 300 includes a clamp 302 and a bolt 304. The clamp 302 comprises a “V” shaped profile. In a typical embodiment, the “V” shaped profile is capable of withstanding greater force while consuming less material. In a typical embodiment, a notch 306 is disposed in the clamp 302. The notch 306 is sufficiently sized to allow a head region 308 of the bolt 304 to be received and secured therein. In a typical embodiment, the notch 306 captures and secures the head region 308 of the bolt 304 and prevents rotation and deflection of the bolt 304 during installation. In a typical embodiment, the clamp system 300 permits securement of a tray such as, for example, the tray 205 (shown in FIG. 2) within a chemical-process column by a single worker located above the tray thereby eliminating the need for multiple workers. Thus, the clamp system 300 allows lower-cost installation.

FIG. 4 is a side view of a clamp system according to an exemplary embodiment. The clamp system 400 includes a clamp 402 and a bolt 404. The clamp 402 includes a long-leg region 416 and a short-leg region 418. In a typical embodiment, the long-leg region 416 engages a bottom surface 407 of a tray 405 while the short-leg region 418 engages a bottom surface 409 of the support 403. A notch 406 is disposed on a side of the clamp 402 corresponding with the long-leg region 416; however, in various alternative embodiments, the notch 406 is located in other positions relative to the long-leg region 416. In a typical embodiment, the notch 406 is sufficiently sized to receive and secure a head region 408 of the bolt 404. The notch 406 captures the head region 408 of the bolt 404 and prevents rotation and deflection of the bolt 404 during tightening of a nut such as, for example the nut 212 (shown in FIG. 2).

FIG. 5 is a side view of a clamp system according to an exemplary embodiment. In a typical embodiment, a clamp system 500 includes a clamp 504 and a bolt 506. In a typical embodiment, the clamp 504 includes a notch 508. The notch 508 is sufficiently sized to receive and secure a head region 510 of the bolt 506. The notch 508 captures the head region 510 of the bolt 506 and prevents rotation and deflection of the bolt 506 during tightening of a nut such as, for example, the nut 212 (shown in FIG. 2). In a typical embodiment, a rounded bolt seat 502 is located within the notch 508. The rounded bolt seat 502 permits movement of the bolt 506 relative to the clamp 504 while allowing the head region 510 of the bolt 506 to remain generally flush with the clamp 504. In various embodiments, the rounded bolt seat 502 permits sufficient movement of the bolt 506 relative to the clamp 504 such that a washer such as, for example, the washer 210 (shown in FIG. 2) is not required. In a typical embodiment, the clamp system 500 permits securement of a tray such as, for example, the tray 205 (shown in FIG. 2) within a chemical-process column by a single worker positioned above the tray thereby eliminating the need for multiple workers. Thus, the clamp system 500 allows lower-cost installation.

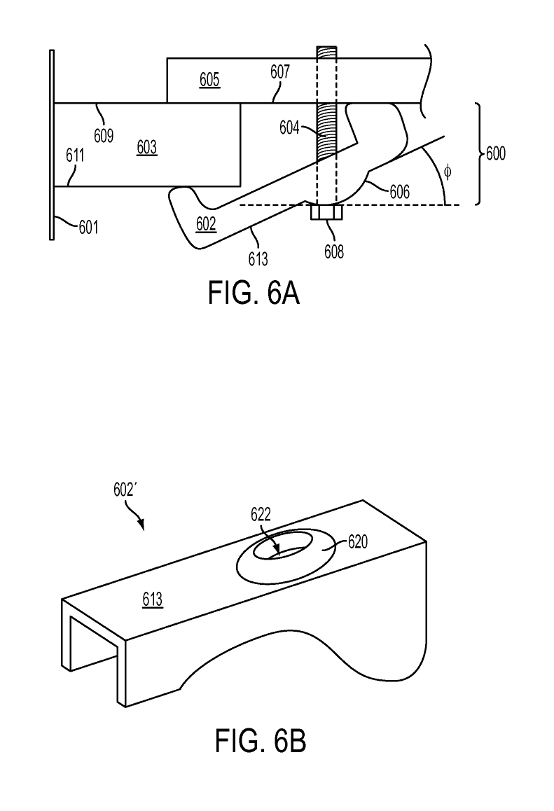

FIG. 6A is a cross-sectional view of a chemical-process column having a clamp system disposed therein according to an exemplary embodiment. In a typical embodiment, a support 603 is secured to an interior of a chemical-process column 601. At least a portion of a bottom surface 607 of a tray 605 is disposed on at least a portion of a top surface 609 of the support 603. In a typical embodiment, a clamp system 600 includes a clamp 602 and a bolt 604. The clamp 602 engages a bottom surface 611 of the support 603. A rounded bolt seat 606 extends from an underside 613 of the clamp 602. In a typical embodiment, the rounded bolt seat 606 may be integrally formed with the clamp 602; however, in various alternative embodiments, the rounded bolt seat 606 may be formed separate from the at least one clamp 602 and attached thereto via a process such as, for example, welding or soldering. In a typical embodiment, the rounded bolt seat 606 allows movement of the bolt 604 relative to the clamp 602.

Still referring to FIG. 6A, in a typical embodiment, the rounded bolt seat 606 permits the bolt 604 to be received at an angle φ relative to the clamp 602. The rounded bolt seat 606 allows the bolt 604 to remain at an angle of generally 90 degrees relative to the tray 605. Such an arrangement permits a head region 608 of the bolt 604 to remain generally flush against the rounded bolt seat 606 thereby reducing a tendency of the bolt 604 or the clamp 602 to deflect toward the center of the tray 605. In various embodiments, a washer (not explicitly shown) is included above the tray 605. In a typical embodiment, the washer is dome shaped and permits a greater range of motion of the bolt 604 beyond that which is represented by the angle φ. In various alternative embodiments, the washer 210 is not required.

FIG. 6B is a bottom perspective view of a clamp 602′. In various embodiments, a rounded bolt seat 620 is formed on the underside 613 of the clamp 602′. The rounded bolt seat 620 is generally circular, ovular, or elliptical in shape and includes an aperture 622 formed therein. The aperture 622 is elongated such that a long axis of the aperture 622 is generally parallel to a long axis of the underside 613 of the clamp 602′. In a typical embodiment, the rounded bolt seat 620 and the aperture 622 facilitate movement of the bolt 604 (shown in FIG. 6A) relative to the clamp 602′.

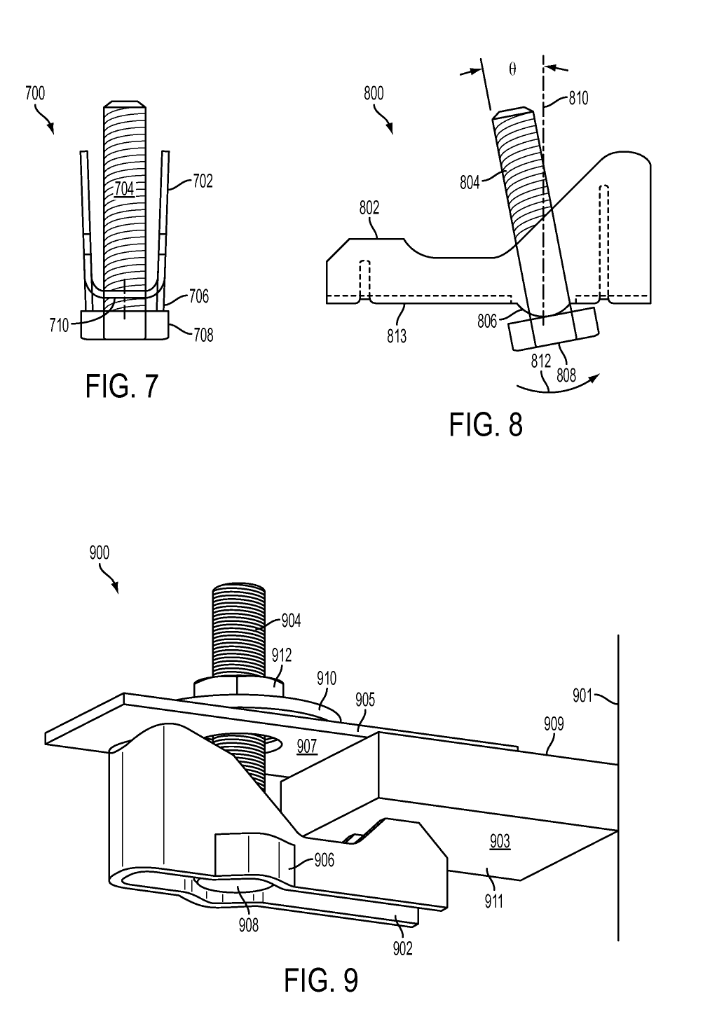

FIG. 7 is an end view of a clamp system of according to an exemplary embodiment. A clamp system 700 includes a clamp 702 and a bolt 704. In a typical embodiment, the clamp 702 comprises a “U” shaped profile. In a typical embodiment, a rounded bolt seat 706 extends from a bottom surface 710 of the clamp 702. The rounded bolt seat 706 permits the bolt 704 to be received at an angle relative to the clamp 704.

FIG. 8 is a side view of a clamp system according to an exemplary embodiment. A clamp system 800 includes a clamp 802 and a bolt 804. A rounded bolt seat 806 extends from an underside 813 of the clamp 802. In a typical embodiment, the rounded bolt seat 806 may be integrally formed with the clamp 802; however, in various alternative embodiments, the rounded bolt seat 806 may be formed separate from the at least one clamp 802 and attached thereto via a process such as, for example, welding or soldering. In a typical embodiment, the rounded bolt seat 806 permits the bolt 804 to be received at an angle θ relative to a vertical axis 810. Such an arrangement permits a head region 808 of the bolt 804 to remain generally flush against the rounded bolt seat 806 thereby reducing a tendency of the bolt 804 or the clamp 802 to deflect in a direction noted by arrow 812.

FIG. 9 is a cross-sectional view of a chemical-process column having a clamp system 900 disposed therein. In a typical embodiment, a support 903 is secured to an interior of a chemical-process column 901. At least a portion of a bottom surface 907 of a tray 905 is disposed on at least a portion of a top surface 909 of the support 903. In a typical embodiment, a clamp system 900 includes a clamp 902 and a bolt 904. The clamp 902 engages a bottom surface 911 of the support 903. In various embodiments, a washer 910 is positioned between the tray 905 and the nut 912. A bolt retainer 906 is formed in the clamp 902. In a typical embodiment, the bolt retainer 906 may be integrally formed with the clamp 902; however, in various alternative embodiments, the bolt retainer 906 may be formed separate from the at least one clamp 902 and attached thereto via a process such as, for example, welding or soldering. In a typical embodiment, bolt retainer 906 receives and secures a head region 908 of the bolt 904 thereby permitting tightening of the bolt 904 by a single worker above the tray 905. In a typical embodiment, the bolt retainer 906 also secures the bolt 904 against accidental disengagement from the clamp 902 during installation. In various embodiments, the bolt retainer 906 receives a nut that is threadably coupled to the bolt 904 and thereby permits tightening of the bolt 904 by a single worker.

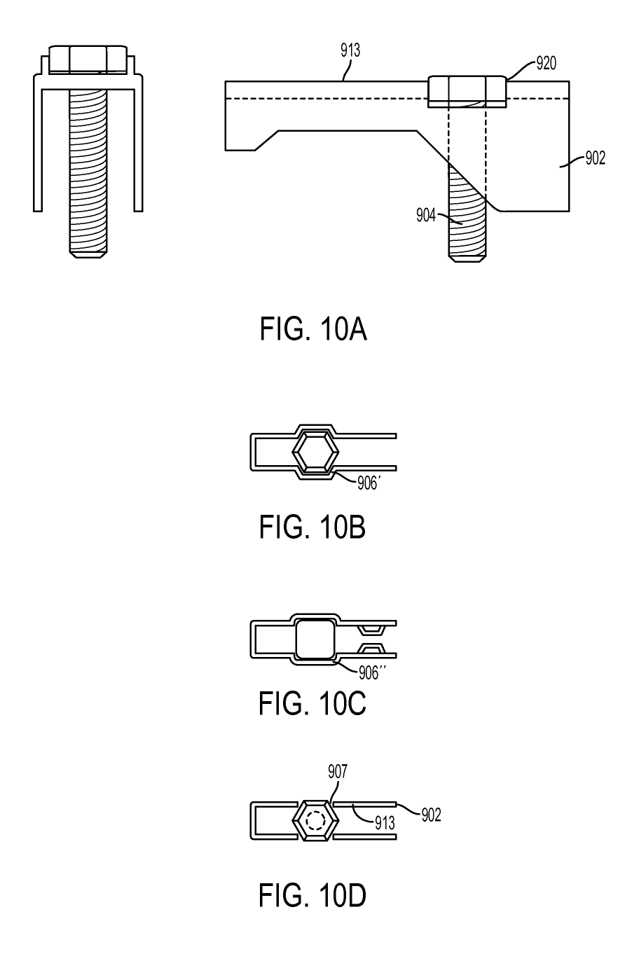

FIG. 10A is a side view of an embodiment of the clamp 902. FIGS. 10B-10C are bottom views of various embodiments of the clamp 902. As shown in FIG. 10A, a plurality of retainer tabs 920 extend from the underside 913 of the clamp 902 in a direction generally perpendicular to the underside 913. The plurality of retainer tabs 920 capture a head region of the bolt 904 and prevent rotation of the bolt 904 during tightening. As shown in FIG. 10B, the bolt retainer 906′ comprises a hex-head shape. As shown in FIG. 10C, the bolt retainer 906″ comprises a four-sided shape. As shown in FIG. 10D, a bolt retainer 907 is cut into the underside 913 of the clamp 902. In a typical embodiment, the bolt retainer 906′ and 906″ capture a head region of the bolt 904 and prevent rotation of the bolt 904 during tightening. In other embodiments, the bolt retainer 906′ or 906″ captures a nut that is threadably coupled to the bolt 904. Although specific shapes have been shown in FIGS. 10A-10D, one skilled in the art will appreciate that clamps utilizing principles of the invention may include bolt retainers of a variety of shapes and sizes.

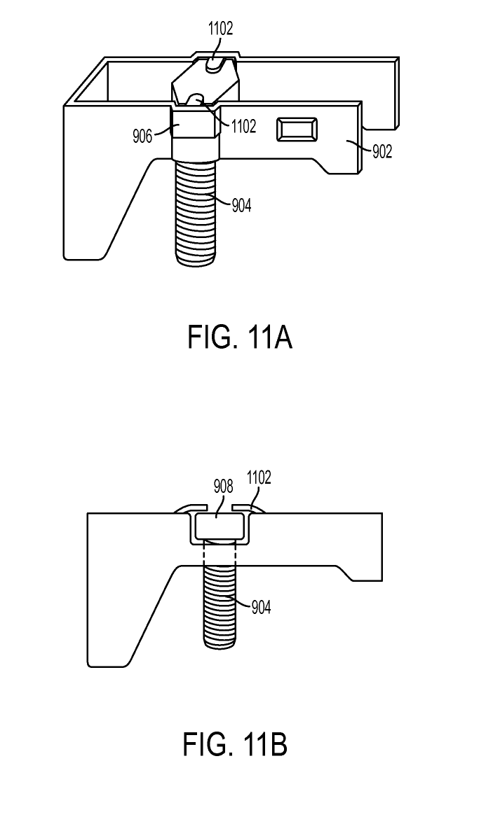

FIG. 11A is a bottom perspective view of the clamp system 900 having bolt retainer tabs 1102. FIG. 11B is a side view of the clamp system 900 having a bolt retainer 907 cut into an underside thereof. In various embodiments, one or more bolt retainer tabs 1102 extend laterally from a bottom edge towards an interior of the bolt retainer 906. In various embodiments, the clamp system 900 may include a single bolt retainer tab 1102. In a typical embodiment, the one or more bolt retainer tabs 1102 further secures the bolt 904 within the bolt retainer 906 and prevents the bolt 904 from becoming disengaged from the clamp 902 by operation of gravity. In other embodiments, the bolt retainer 906 or 907 secures a nut associated with the bolt 904 and prevents the nut from becoming disengaged from the clamp 902.

Although various embodiments of the method and system of the present invention have been illustrated in the accompanying Drawings and described in the foregoing Detailed Description, it will be understood that the invention is not limited to the embodiments disclosed, but is cable of numerous rearrangements, modifications and substitutions without departing from the spirit of the invention as set forth herein.

What is claimed is:

1. A chemical-process system comprising:
a chemical-process column;
a support disposed on an interior of the chemical-process column;
a tray disposed on a top surface of the support;
a bolt disposed through the tray;
a clamp disposed below the tray, the clamp having a bolt retainer formed therein for receiving a head region of the bolt;
wherein the clamp engages a bottom surface of the tray and a bottom surface of the support; and
wherein, the bolt is able to angularly displace with respect to at least one of the tray and the clamp.

2. The chemical-process system of claim 1, wherein the clamp comprises a generally U-shaped profile.

3. The chemical-process system of claim 1, wherein the clamp comprises a generally V-shaped profile.

4. The chemical-process system of claim 1, wherein the clamp comprises a rounded bolt seat on an underside of the clamp, wherein the rounded bolt seat permits angular displacement of the bolt with respect to the clamp.

5. The chemical-process system of claim 4, wherein the rounded bolt seat defines an elongated aperture.

6. The chemical-process system of claim 5, wherein the elongated aperture facilitates angular displacement of the bolt.

7. The chemical-process system of claim 1, wherein:
the bolt is secured by a nut disposed on a top surface of the tray;
the bolt retainer captures the head region of the bolt and prevents rotation of the bolt during tightening of the nut; and
wherein the nut is tightened by a single worker located on the top surface of the tray.

8. The chemical-process system of claim 1, wherein the clamp comprises a long-leg region and a short-leg region.

9. The clamp system of claim 8, wherein:
the long-leg region engages the bottom surface of the tray; and
the short-leg region engages the bottom surface of the support.

10. A method for securing a tray in a chemical-process column, the method comprising:
placing the tray on a support formed on an interior of the chemical-process column;
disposing a bolt through the tray;
positioning a clamp below the tray, the clamp being engaged with the bolt, the bolt engaging a rounded bolt seat formed on a bottom surface of the clamp;
engaging the clamp with a bottom surface of the tray and a bottom surface of the support;
securing the tray to the support via a clamp system comprising a clamp and a bolt; and
articulating the bolt with respect to at least one of the clamp or the tray via an elongated aperture formed in the rounded bolt seat.

11. The method of claim 1, wherein the articulating comprises articulating the bolt centerline as perpendicular relative to the clamp.

12. The method of claim 1, wherein the clamp comprises a generally U-shaped profile.

13. The method of claim 1, wherein the clamp comprises a generally V-shaped profile.

14. The method of claim 1, wherein the articulating comprises angularly displacing the bolt via a rounded bolt seat.

15. The method of claim 5, wherein the rounded bolt seat is comprises a generally circular shape.

16. The method of claim 1, wherein the articulating comprises angularly displacing the bolt via a dome-shaped washer.

17. The method of claim 7, wherein the dome-shaped washer engages the bolt head and is disposed on a top surface of the tray.

18. The method of claim 1, wherein the securing comprises:
securing a head region of the bolt via a bolt retainer; and
tightening a nut disposed on a top surface of the tray, the nut operatively engaged with the bolt.
